(19) United States
(12) Patent Application Publication
(10) Pub. No.: US 2008/0242172 A1
(43) Pub. Date: Oct. 2, 2008

(54) Adhesion-activated polyester monofilaments, elastomeric composites and use thereof

(76) Inventors: Kurt-Gunter Berndt, Graben (DE); Rex Delker, Wehringen (DE); Herbert Hofmann, Konigsbrunn (DE)

Correspondence Address: FERRELLS, PLLC, P. O. BOX 312, CLIFTON, VA, 20124-1706, US

(21) Appl. No.: 12/072,847

(22) Filed: Feb. 28, 2008

(30) Foreign Application Priority Data
Mar. 8, 2007 (DE) DE 102007011566.2

(51) Int. Cl. D02G 3/36; B32B 5/02

(52) U.S. Cl. 442/60; 428/378

(57) ABSTRACT

Described are polyester monofilaments having a surficially applied glycidyloxyalkylenetrialkoxysilane-containing finish. They are notable for particularly good adhesion in elastomers.

### CLAIM FOR PRIORITY

This application is based upon German Patent Application No. DE 10 2007 011 566.2, entitled “Haftungsaktivierte Polyestermonofilamente, Elastomerverbunde und deren Verwendung”, filed Mar. 8, 2007. The priority of German Patent Application No. DE 10 2007 011 566.2 is hereby claimed and its disclosure incorporated herein by reference.

### TECHNICAL FIELD

The present invention provides monofilaments having excellent rubber adhesion which are useful for producing reinforced elastomeric composites in particular. Reinforced elastomeric composites are useful for example in rubber hoses or in conveyor belts.

### BACKGROUND

Polyester monofilaments generally have little adhesion to elastomeric plastics. Adhesion problems therefore frequently arise in the processing of rubber articles. Poor adhesion manifests itself in insufficient bonding of the reinforcing material into the polymer matrix and ultimately in insufficient reinforcement of the elastomer.

Applying sizes to improve fiber-rubber adhesion is known per se. WO-A-2002/95,102 describes a method of producing tire cords. Therein, different materials are processed into cords and provided with a rubber-friendly finish. To improve the adhesion between the fibers and the elastomeric matrix, it is proposed to provide the fibrous yarns with an adhesion promoter, for example with epoxysilanes.

DE-A-20 13 552 describes a process for improving the adherability of polyester products wherein the products are treated in two stages. They are drenched with a liquid comprising a selected silane compound in the first stage and treated with a resorcinol-formaldehyde latex in the second stage. Useful silane compounds include a gamma-glycidyloxypropyltrimethoxysilane. Different polyester products can be used, including strands, fibers, yarns and cords. The treatment of multifilament yarns and also of cords therefrom is more particularly elucidated in the description. The use of monofilaments is not disclosed.

EP-A-43,410 describes a process for producing adhesive finished polyester yarns and also products obtained therefrom. This process comprises treating a yarn, i.e., a structure composed of a multiplicity of strands, with a size comprising glycidyloxyalkyltrimethoxysilane adhesion promoter. Again, the treatment of multifilament yarns and also of cords therefrom is more particularly elucidated in the description. The use of monofilaments is not disclosed.

To process glass fiber reinforced plastics, for example in the manufacture of circuit boards, the use of adhesion promoters to improve fiber-matrix adhesion is known (cf. for example EP-A-321,977). A suitable aqueous finish with pH regulator for coating glass fibers is disclosed in U.S. Pat. No. 4,656,084.

Also already known are monofilaments composed of different plastics and surficially coated with abrading and polishing agents and finished with a wide variety of adhesion promoters, including epoxysilanes, to improve adhesion between the monofilament and the surface coating (cf. WO-A-96/23,431).

True, it is known to finish yarns and in particular cords therefrom with sizes comprising glycidyloxyalkyltrialkoxysilane and subsequently provide them with a resorcinol-formaldehyde latex dip before incorporation in a rubber matrix. Owing to their construction from a multiplicity of strands, such products are notable for a large surface area. In addition, owing to capillary forces, such products take up a comparatively high proportion of size. Monofilaments by contrast have an appreciably smaller surface area and do not give rise to any capillary forces either. A person skilled in the art was hitherto of the opinion that the usual practice with yarns of providing a rubber-friendly finish would not be successful with monofilaments.

### SUMMARY OF INVENTION

It has now been found that a selective group of adhesion promoters, surprisingly, on application to the surface of polyester monofilaments, very substantially improve the adhesion between an elastomeric matrix and the monofilament.

The invention accordingly provides a polyester monofilament having a surficially applied glycidyloxyalkylenetrialkoxysilane-containing finish.

### DETAILED DESCRIPTION

The invention is described in detail below with reference to several embodiments and numerous examples. Such discussion is for purposes of illustration only. Modifications to particular examples within the spirit and scope of the present invention, set forth in the appended claims, will be readily apparent to one of skill in the art. Terminology used herein is given its ordinary meaning consistent with the exemplary definitions set forth immediately below.

The problem solved by the present invention is therefore to provide monofilaments having a rubber-friendly finish which exhibit very good adhesion in a composite with an elastomer.

Monofilaments herein are individual strands. Their diameter is typically in the range from 100 to 1000 μm and preferably in the range from 200 to 500 μm.

The length of these monofilaments can vary from a few millimeters to continuous (i.e., lengths of up to several kilometers).

The linear density of the monofilaments of the present invention can vary within wide limits, for example in the range from 100 to 15 000 dtex and in particular in the range from 400 to 3000 dtex.

The cross-sectional shape of the monofilaments of the present invention is freely choosable, examples being round, oval or n-gonal, where n is not less than 3.

The monofilaments of the present invention can be present as one-component strands or as multi-component strands. Examples of multi-component strands are side-by-side strands or in particular core-sheath strands. In the latter, the core preferably consists of a polyester which determines the mechanical properties of the monofilament, while the sheath consists of polyester admixed with functional additives which determine the performance characteristics of the monofilament.

Useful polyesters for constructing the monofilaments of the present invention include very generally any desired strand-forming polyesters.

Preference is given to using monofilaments composed of polyethylene terephthalate homopolymers or of copolymers comprising ethylene terephthalate units. These polymers are thus derived from ethylene glycol and if appropriate further alcohols and also from terephthalic acid and its polyester-forming derivatives, such as terephthalic acid or terephthaloyl chlorides.

However, monofilaments composed of other polyesters, such as polybutylene terephthalate, polypropylene terephthalate, polyethylene naphthalate homopolymer or copolymers comprising ethylene-naphthalate units can be used.

These thermoplastic polyesters are known per se. Building blocks of thermoplastic copolyesters are preferably the abovementioned diols and dicarboxylic acids, or correspondingly constructed polyester-forming derivatives.

As well as ethylene glycol, these polyesters may comprise structural units derived from suitable dihydric alcohols. Typical representatives thereof are aliphatic and/or cycloaliphatic diols, for example propanediol, 1,4-butanediol, cyclohexanedimethanol or mixtures thereof.

The monofilaments of the present invention are preferably derived from polyesters whose intrinsic viscosities (IV values) amount to at least 0.60 dl/g, preferably in the range from 0.60 to 1.05 dl/g and more preferably in the range of 0.62-0.93 dl/g (measured at 25° C. in dichloroacetic acid (DCE)).

The monofilaments of the present invention can be produced by conventional melt-spinning processes, combined with single or multiple drawing and if appropriate setting of the monofilaments obtained.

After spinning, the finish used according to the present invention is applied to the surface of the monofilament, for example by spray application or by using a spin-finish roll. Typically, spin finishing is carried out in the manufacturing operation of the monofilament after drawing or setting and before winding. However, application can also be to ready-produced monofilaments by after-treating them with the adhesion-activating finish to render them rubber adhesion activated.

Customary spin finish rolls have diameters of 20 to 250 mm with treated surfaces which permit particularly efficient application.

The finish as well as the glycidyloxyalkylenetrialkoxysilane may comprise further constituents. Examples thereof are water, emulsifiers and antistats.

The glycidyloxyalkylenetrialkoxysilanes preferred for use according to the present invention preferably include compounds of the general formula I or II:

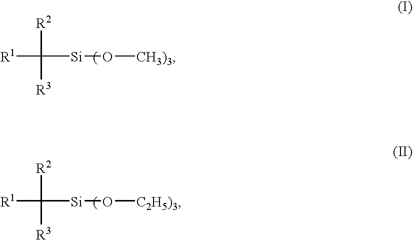

where
R¹ is —(CH₂)ₘ—O—R⁴,
R² is hydrogen, —(CH₂)ₙ—CH₃ or R¹,
R³ is hydrogen, —(CH₂)ₒ—CH₃ or R², and
R⁴ is

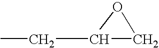

where m, n and o are each independently an integer between 0 and 12.

Particularly preferred compounds from this group are compounds of the formula III

(R⁵—O)₃—Si—(CH₂)ₚ—O—R⁶ (III),
where
R⁵ in each occurrence is independently hydrogen or particularly C₁-C₆-alkyl, most preferably methyl, ethyl or propyl,
R⁶ is glycidyl (1,2-epoxypropyl), and
p is an integer between 1 and 12, in particular from 2 to 4.

Very particular preference is given to using 3-glycidyloxypropyltriethoxy-silane and/or 3-glycidyloxypropyltrimethoxysilane.

The epoxysilane is applied to the monofilament in an amount sufficient for the desired application. Typical amounts vary from 0.001% to 0.5% by weight, based on the mass of the finished monofilament, preferably 0.01% to 0.25% by weight and more preferably 0.01% to 0.15% by weight.

The monofilaments of the present invention may comprise still further, adjunct materials.

Examples are hydrolysis stabilizers, processing assistants, antioxidants, plasticizers, lubricants, pigments, delusterants, viscosity modifiers or crystallization accelerants.

Examples of processing assistants are siloxanes, waxes or comparatively long-chain carboxylic acids or salts thereof, aliphatic, aromatic esters or ethers.

Examples of antioxidants are phosphorus compounds, such as phosphoric esters or sterically hindered phenols.

Examples of pigments or delusterants are organic dye pigments or titanium dioxide.

Examples of viscosity modifiers are polybasic carboxylic acids and their esters or polyhydric alcohols.

The present invention's monofilaments which have been provided with a finish are notable for particularly good adhesion to elastomers.

The monofilaments of the present invention are preferably used for producing textile fabrics, in particular woven fabrics, laid fabrics, formed-loop knits, braids or drawn-loop knits. These textile fabrics are preferably used as reinforcing materials in elastomers.

For this use, the textile fabrics are preferably additionally coated with a polymeric latex before incorporation in the elastomeric matrix. Coating with a polymeric latex is customarily done by dipping the adhesion-activated textile fabric into a dispersion of this polymeric latex.

Textile fabrics comprising the monofilaments of the present invention, in particular the types coated with polymeric latex, likewise form part of the subject matter of this invention.

This invention further provides composites comprising an elastomeric polymeric matrix and embedded therein at least one textile fabric comprising the monofilaments of the present invention.

Useful elastomers include all natural and/or synthetic rubbers known to one skilled in the art.

The present invention also provides for the use of the herein described polyester monofilaments in composites with elastomers.

The composites of the present invention are preferably used as conveyor belts or as hoses.

The examples which follow elucidate the invention without limiting it.

### EXAMPLE

A polyester standard monofilament 0.25 mm, type 900 S, from Teijin Monofilament Germany GmbH, Bobingen was used.

The monofilament was led in contact over a spin finish roll turning contrary to the monofilament's direction of transport. APS product from Schill & Seilacher AG, Boblingen was used as adhesion-activating finish. The lower part of the spin finish roll dipped into the finish, wetted the surface and transferred a portion of the finish to the monofilament at top dead center. Finish add-on depended on the rate of rotation of the spin finish roll, the monofilament speed and the temperature. The add-on was measured in % by weight, based on the ready-finished monofilament.

Production of the elastomeric composite and measurement of rubber adhesion were performed by the T-test according to ATSM D 2229-73.

Details as to monofilaments, add-on and rubber adhesion results appear in Table 1.

The table which follows shows the results of the adhesion measurements.

TABLE 1
Add-On and Rubber Adhesion Measurements

| | | Duration of | | |
|---|---|---|---|---|
| | Finish add-on | storage | Adhesion | |
| Example No. | (% by weight) | (days) | (N/0.5 cm) | Comments |
| Comparative 1 | 0.00 | 0 | 16.72 | |
| 2 | 0.03 | 0 | 29.58 | mono- |
| | | | | filaments |
| | | | | rupture |
| 3 | 0.03 | 28 | 30.01 | mono- |
| | | | | filaments |
| | | | | rupture |

While the invention has been described in connection with several examples, modifications to those examples within the spirit and scope of the invention will be readily apparent to those of skill in the art. In view of the foregoing discussion, relevant knowledge in the art and references discussed above in connection with the Background and Detailed Description, the disclosures of which are all incorporated herein by reference, further description is deemed unnecessary.

What is claimed is:

1. A polyester monofilament having a surficially applied glycidyloxyalkylene-trialkoxysilane-containing finish.

2. The polyester monofilament as claimed in claim 1 wherein the polyester is a polyethylene terephthalate homopolymer or a polyethylene terephthalate copolymer which as well as polyethylene terephthalate units comprises units derived from aliphatic, cycloaliphatic or aromatic dicarboxylic acids or their polyester-forming derivatives or from aliphatic or cycloaliphatic dialcohols.

3. The polyester monofilament as claimed in claim 1 wherein the glycidyloxyalkylenetrialkoxysilane is glycidyloxypropyltrimethoxysilane.

4. The polyester monofilament as claimed in claim 1 having a linear density in the range from 100 to 15 000 dtex.

5. The polyester monofilament as claimed in claim 1 surface coated with a polymer latex in addition to the glycidyloxyalkylenetrialkoxysilane-containing finish.

6. The polyester monofilament as claimed in claim 1 wherein the glycidyloxyalkylenetrialkoxysilane has been applied in an amount of 0.001 to 0.25% by weight.

7. A textile fabric, in particular a woven, knit, braided or laid fabric, comprising polyester monofilaments as claimed in claim 1.

8. A composite comprising an elastomeric polymeric matrix and, embedded therein, at least one textile fabric as claimed in claim 7.

9. The use of a polyester monofilament as claimed in claim 1 in composites with elastomers.

10. The use as claimed in claim 9 wherein the composites with elastomers are used as conveyor belts or hoses.
